(19) United States
(12) Patent Application Publication
(10) Pub. No.: US 2021/0280960 A1
(43) Pub. Date: Sep. 9, 2021

(54) DEVICES WITH BEZELS TO REDUCE RESONANCE SHIFT IN ANTENNAS

(71) Applicant: HEWLETT-PACKARD DEVELOPMENT COMPANY, L.P., Spring, TX (US)

(72) Inventors: Kuan-Jung HUNG, Taipei (TW); Cheng-Ming LIN, Taipei (TW)

(73) Assignee: Hewlett-Packard Development Company, L.P., Spring, TX (US)

(21) Appl. No.: 16/481,499

(22) PCT Filed: Oct. 17, 2017
(86) PCT No.: PCT/US2017/056997

§ 371 Date: Jul. 29, 2019

(51) Int. Cl. H01Q 1/24; G06F 1/16; H01Q 1/00

(52) U.S. Cl. CPC H01Q 1/243; G06F 1/1698; H01Q 1/005; G06F 1/1658; G06F 1/1626

(57) ABSTRACT

An example of a device including a display panel and a border region around the display panel is provided. The device includes a cover disposed on the display panel and the border region. The cover is to protect the display panel and the border region. The device also includes an antenna with a keep out area disposed within a portion of the border region. The device includes a bezel disposed in the keep out area to support the cover. The bezel includes a partially filled portion to reduce a resonance shift of the antenna.

### BACKGROUND

Computing devices, such as laptops, tablets, and smartphones, generally include an antenna for sending and receiving signals over a wireless network. As devices become more compact, locations in which the antenna is placed is more restricted causing components of the computing device to interfere with antenna performance. In general, the interference cannot be avoided and becomes a factor when tuning the antenna. For example, a typical location of the antenna in a computing device is in the border region around a display panel. In such a location, the antenna is close to other components such as a plastic bezel which may affect the antenna performance.

### BRIEF DESCRIPTION OF THE DRAWINGS

Reference will now be made, by way of example only, to the accompanying drawings in which:

FIG. 1 is a top view of a device in accordance with an example;

FIG. 2 is a partial cross sectional view of the device of FIG. 1 through the line 2-2;

FIG. 3 is a top view of a device in accordance with another example;

FIG. 4 is a partial cross sectional view of the device of FIG. 3 through the line 4-4;

FIG. 5 is a partial cross sectional view of a device in accordance with another example; and

FIG. 6 is a flowchart of an example method.

### DETAILED DESCRIPTION

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

In describing the components of the device and alternative examples of some of these components, the same reference number can be used for elements that are the same as, or similar to, elements described in other examples. As used herein, any usage of terms that suggest an absolute orientation (e.g. “top”, “bottom”, “front”, “back”, etc.) are for illustrative convenience and refer to the orientation shown in a particular figure. However, such terms are not to be construed in a limiting sense as it is contemplated that various components will, in practice, be utilized in orientations that are the same as, or different than those described or shown.

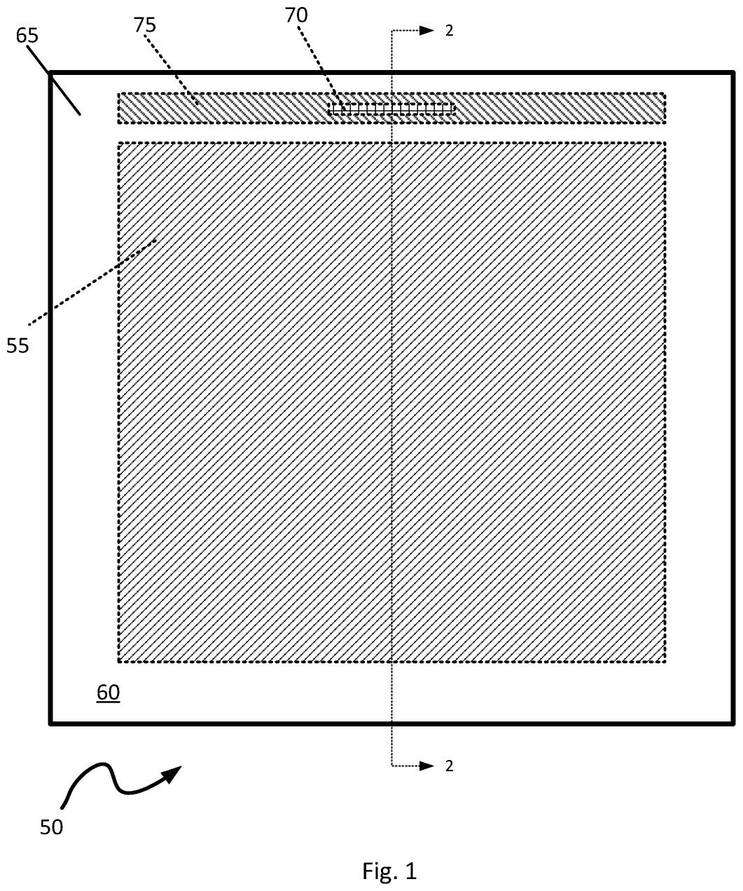

Referring to FIG. 1, a device is generally shown at 50. The device 50 is not particularly limited and can be a mobile computing device, such as a laptop computer, a tablet, a smartphone, a wearable device, or a head mounted display capable to connect to wireless networks, such as a wireless wide area network, a wireless local area network, and the global navigation satellite system. In the present example, the device 50 is a tablet capable to connect to a Wi-Fi network, such as one that operates at 2.45 GHz. However, in other examples, the device 50 may be configured to connect to another wireless network, such as a cellular network or a closed wireless network. In the present example, the device 50 includes a display panel 55, a border region 60, a cover 65, an antenna 70, and a bezel 75.

The display panel 55 is to display information for a user. For example, the display panel 55 can include one or more light emitters such as an array of light emitting diodes (LED), liquid crystals, plasma cells, or organic light emitting diodes (OLED). Other types of light emitters can also be substituted. Furthermore, an optional touch membrane can be overlaid on the display panel 55 to provide a touchscreen input device. The touch membrane is not limited to any type of touch membrane and can include resistive technology, surface acoustic wave technology, capacitive technology, infrared technology, or optical imaging technology.

The border region 60 around the display panel 55 is an area that is typically required to provide the structural components to support and protect the display panel 55. For example, the border region 60 generally includes additional plastic or metal features to securely hold the display panel 55 in place and to prevent damage from shock such a fall or drop of the device 50. In addition, the border region 60 can also provide a location to store various other components of the device 50, such as a battery, various circuitry, speakers, microphones, and as discussed in greater detail below, an antenna.

The cover 65 is disposed over the display panel 55 and extends over the border region 60 as well. In the present example, the cover 65 is a hard transparent material, such as glass, sapphire, plastic, etc. to protect the display panel 55 and any components disposed within the border region 60. In other examples, the cover 65 can be made from different materials over the display panel 55 and the border region 60. In particular, since the cover 65 does not need to be transparent over the border region 60, an opaque material can be used.

The antenna 70 is disposed within the border region 60 of the device 50. The antenna 70 is not limited and can be any type of antenna to communicate with a base station (not shown) to provide connectivity to a server or other device via the wireless network. In the present example, the antenna 70 is configured to provide connectivity to a Wi-Fi network that operates at the 2.45 GHz frequency. The antenna 70 also typically has a keep-out area by design in which other components, such as dielectric materials may affect the performance of the antenna 70. The exact distance and size of the keep-out area is generally a matter of antenna design and can vary from one design to another. For example, the keep-out area can be defined as a volume above the antenna 70 extending up to 5 mmabove a surface.

It is to be appreciated that the design and assembly of compact computing devices, such as tablets, smartphones, and laptop computers, does not generally allow for regions of empty space to maintain a clear keep-out area. Accordingly, structural and electronic components can sometimes be placed within the keep-out zone that may alter the performance of the antenna 70. For example, the resonance frequency of an antenna may be shifted when a dielectric material, such as a structural component of the device 50 is disposed within the keep-out area. In a device 50 where the shift in the resonance frequency is predictable, the antenna 70 can then be designed to account for this shift. As an example, if it is known the components around an antenna 70 will shift the frequency lower by 0.45 GHz and the target peak response of the antenna is 2.45 GHz, the antenna 70 can be designed to have a resonance frequency of 2.9 GHz. The design of an antenna 70 to have the resonance frequency shifted significantly may create difficulties in the design of the device 50 as well as limit the selection of available antenna types for the device 50. Accordingly, a reduction in the shift of resonance frequency may provide improved performance of the device, since the radiator dimension will not be as limited. For example, the amount of reduction of the the radiator dimension may be reduced.

The bezel 75 is disposed over the antenna 70 in the keep-out area of the antenna 70 to support the cover 65 above the antenna 70. This bezel 75 is to support the cover 65 over the border region 60 as well as the display panel 55 which operates in conjunction with other support elements in other portions of the border region 60. The bezel 75 reduces contact between the cover 65 and the antenna 70 as well as the display panel 55. This provides protection to the antenna 70 and the display panel 55 since the cover 65 may be subjected to various stresses and vibrations that can damage sensitive components of the device 50.

In the present example, the bezel 75 is made from an elongated material, such as a dielectric material, dimensioned to fit in a portion of the border region 60. Although the bezel 75 is in a single side of the border region 60 in the illustration in FIG. 1, it is to be appreciated that the bezel 75 can be in multiple sides of the border region 60 and can be modified dependent on whether there is another component within the border region 60 at that location. In this example, the bezel 75 is made from a plastic and is designed to have a uniform dielectric constant across the bezel 75. In this example, the bezel 75 has a substantially uniform thickness of about 0.7 mm in most areas (except for some portions as discussed in more detail below). In other examples, the bezel 75 can be modified to be thicker, such as up to 1.0 mm or more, to provide additional protect to the device 50 at the costs of production of the device 50 larger. Alternatively, the bezel 75 can also be modified to be thinner, such as about 0.6 mm or less to provide a more compact design of the device 50. However, a thinner bezel 75 decrease the distance to the cover 65 and may reduce the protection of the components of the device 50.

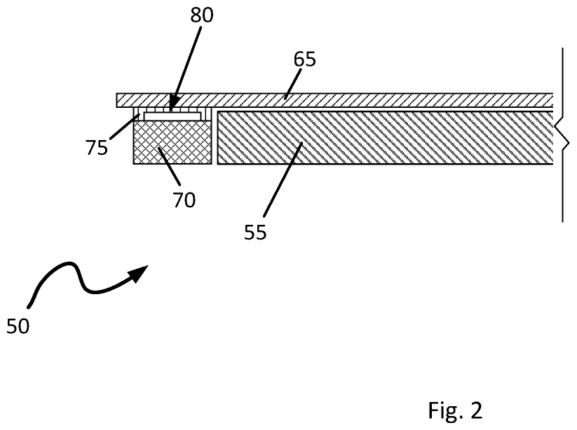

As shown in FIG. 1 and better illustrated in FIG. 2, the bezel 75 further includes a partially filled portion 80 where the thickness of the bezel 75 is reduced. The partially filled portion 80 is to reduce the resonance shift of the antenna 70. Accordingly, the partially filled portion 80 is generally formed in a location on the bezel 75 that may be within the keep-out area of the antenna 70. The formation of the partially filled portion 80 is not limited and a variety of methods may be used. In the present example, the partially filled portion 80 is formed by removal of material from the bezel 75 with uniform thickness. The manner by which the material is removed is also not limited and may include cutting, grinding or etching away material. Alternatively, the partially filled portion 80 may be formed during the molding process of the bezel 75. In particular, a mold with the partially filled portion 80 may be used.

The size and the amount that the thickness of the bezel 75 is reduced are not particularly limited. In the present example, the partially filled portion 80 is about 12 mm long and 3 mm wide. With an increase in the size of the partially filled portion 80, the reduction in the resonance frequency shift is improved. However, if the partially filled portion 80 is too large, the structural integrity of the bezel 75 may be compromised.

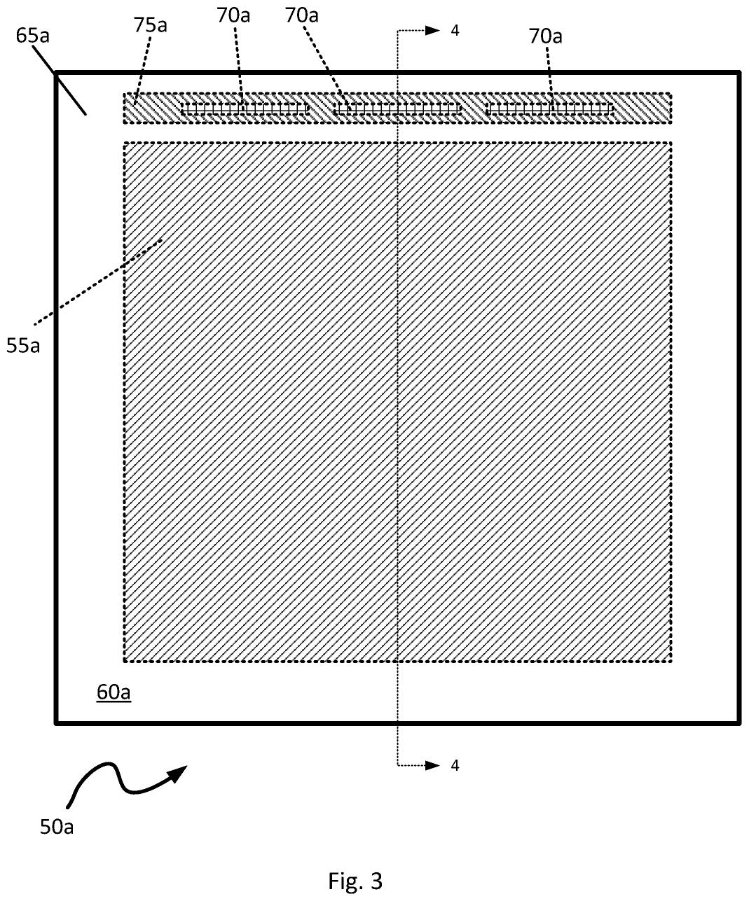

Referring to FIG. 3, another device is generally shown at 50a. Like components of the device 50a bear like reference to their counterparts in the device 50, except followed by the suffix “a”. In the present example, the device 50a includes a display panel 55a, a border region 60a, a cover 65a, an antenna 70a, a bezel 75a, and shielding 85a.

In the present example, the display panel 55a is to display information for a user. For example, the display panel 55a can include one or more light emitters such as an array of light emitting diodes (LED), liquid crystals, plasma cells, or organic light emitting diodes (OLED). Other types of light emitters can also be substituted. Furthermore, an optional touch membrane can be overlaid on the display panel 55 to provide a touchscreen input device. The touch membrane is not limited to any type of touch membrane and can include resistive technology, surface acoustic wave technology, capacitive technology, infrared technology, or optical imaging technology.

The border region 60a around the display panel 55a is an area that is typically required to provide the structural components to support and protect the display panel 55a. For example, the border region 60a generally includes additional plastic or metal features to securely hold the display panel 55a in place and to prevent damage from shock such a fall or a drop of the device 50a. In addition, the border region 60a can also provide a location to store various other components of the device 50a, such as a battery, various circuitry, speakers, microphones, and the antenna 70a.

The cover 65a is disposed over the display panel 55a and extends over the border region 60a as well. In the present example, the cover 65a is a hard transparent material, such as glass or sapphire to protect the display panel 55a and any components disposed within the border region 60a. In other examples, the cover 65a can be made from different materials over the display panel 55a and the border region 60a.

The antenna 70a is mounted within the border region 60a of the device 50. The manner by which the antenna 70a is mounted can be varied and may include the use of glue to hold the antenna 70a in place or using a fastener. The antenna 70a is not limited and can be any type of antenna to connect to a wireless network to provide connectivity. In the present example, the antenna 70a is configured to provide connectivity to a Wi-Fi network that operates at the 2.45 GHz frequency. The antenna 70a typically has a keep-out area by design in which other components, such as dielectric materials may affect the performance of the antenna 70a. The exact distance and size of the keep-out area is generally a matter of antenna design and can vary from one design to another.

The bezel 75a is disposed over the antenna 70a in the keep-out area of the antenna 70a to support the cover 65a above the antenna 70a. This bezel 75a is to support the cover 65a over the border region 60a as well as the display panel 55a that operates in conjunction with other support elements in other portions of the border region 60a. The bezel 75a reduces contact between the cover 65a and the antenna 70a as well as the display panel 55a. This provides protection to the antenna 70a and the display panel 55a since the cover 65a may be subjected to various stresses and vibrations that can damage sensitive components of the device 50a.

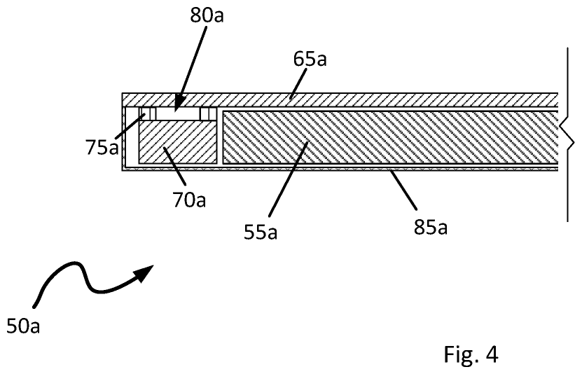

As shown in FIG. 3 and better illustrated in FIG. 4, the bezel 75a further includes a plurality of partially filled portions 80a where the bezel 75a includes a cutout section, where there is no dielectric material. Use of a cutout section as the partially filled portions 80a reduces the resonance shift of the antenna 70a more than by use of a reduction to the thickness as in the bezel 75. Accordingly, the partially filled portions 80a are generally formed in a location on the bezel 75a that may be within the keep-out area of the antenna 70a. The formation of the cutout section is not limited and a variety of methods may be used. In the present example, the cutout section is formed by removal of material from the bezel 75a with uniform thickness. The manner by which the material is removed is also not limited and may include cutting, punching, grinding or etching away material. Alternatively, the cutout section may be formed during the molding process of the bezel 75a.

The device 50a includes shielding 85a to protect components of the device 50 from the bottom as shown in FIG. 4. The shielding 85a can also provide structural stability to the device 50a and a rigid barrier between the components of the device 50a and the external environment. In some examples, the shielding can be made from metal to provide electromagnetic shielding to the components of the device 50a.

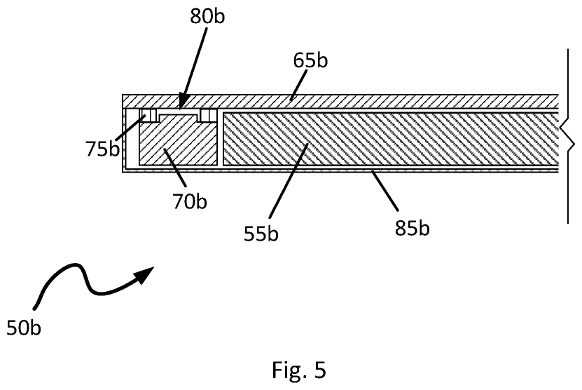

Referring to FIG. 5, the cross sectional view of another device is generally shown at 50b. Like components of the device 50b bear like reference to their counterparts in the device 50a, except followed by the suffix “b”. In the present example, the device 50b includes a display panel 55b, a border region 60b, a cover 65b, an antenna 70b, a bezel 75b, and shielding 85b.

In this example, the partially filled portion 80b is also a cutout section. Further, the antenna 70b extends into the cutout section of the bezel 75b. Extension of the antenna 70b into the cutout section allows for the height of the antenna 70b to be increased up to the thickness of the bezel 75b without contact with the cover 65b which may improve antenna radiation performance accordingly.

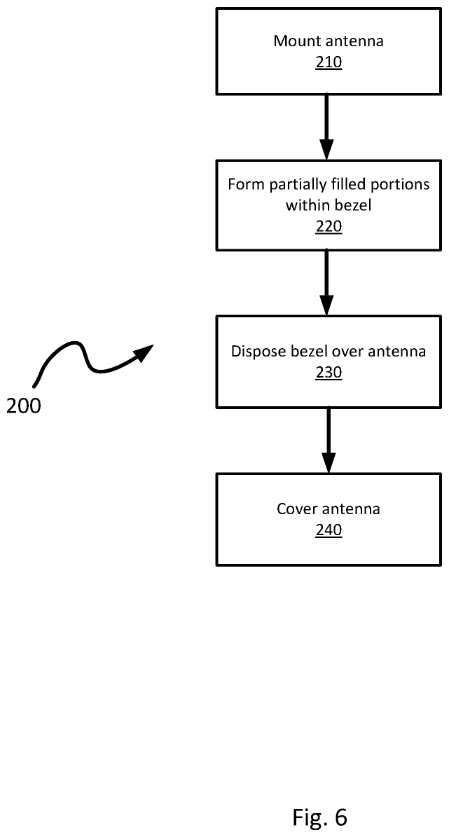

Referring to FIG. 6, a flowchart of method of a manufacturing a device is shown at 200. In order to assist in the explanation of method 200, it will be assumed that method 200 may be performed to manufacture the device 50, 50a, or 50b. Furthermore, the following discussion of method 200 may lead to a further understanding of the device 50, 50a, or 50b along with their various components.

Beginning at block 210, an antenna 70 is mounted in a border region 60 around a display panel 55. As discussed above, the antenna 70 also includes a keep-out area. The manner by which the antenna 70 is mounted is not particularly limited. For example, the antenna can be mounted with glue, fasteners or a friction fit.

Next, at block 220, partially filled portion 80 is formed with the bezel 75. The partially filled portion 80 may be formed by cutting, punching, grinding or etching away material. Alternatively, the partially filled portion 80 may be formed during the molding process of the bezel 75. In some examples, the partially filled portion 80 may be a cutout section to receive a portion of the antenna with an increased height.

Block 230 involves the placement of the bezel 75 within the keep out area of the over the antenna 70. This bezel 75 is to support the cover 65 over the border region 60 as well as the display panel 55 that operates in conjunction with other support elements in other portions of the border region 60. The bezel 75 reduces contact between the cover 65 and the antenna 70 as well as the display panel 55. This provides protection to the antenna 70 and the display panel 55 since the cover 65 may be subjected to various stresses and vibrations that can damage sensitive components of the device 50.

Block 240 involves using a cover 65 supported by the bezel 75 to cover the antenna 70. In this example, the bezel 75 provides additional protection for the internal components of the device 50 by separation of the cover 65 from the components, such as the antenna 70 and the display panel 55.

Variations to the above devices are contemplated. For example, the device 50 can be modified to have the shielding 85a or the plurality of partially filled portions 80a of the device 50a.

It should be recognized that features and aspects of the various examples provided above may be combined into further examples that also fall within the scope of the present disclosure.

What is claimed is:

1. A device comprising:
a display panel;
a border region around the display panel;
a cover disposed on the display panel and the border region, the cover to protect the display panel and the border region;
an antenna disposed within a portion of the border region, wherein the antenna has a keep-out area; and
a bezel disposed in the keep-out area to support the cover, wherein the bezel includes a partially filled portion to reduce a resonance shift of the antenna.

2. The device of claim 1, wherein the bezel is a dielectric material.

3. The device of claim 2, wherein the dielectric material is plastic.

4. The device of claim 3, wherein the partially filled portion is a cutout section.

5. The device of claim 4, wherein the antenna extends into the cutout section to increase height.

6. The device of claim 5, wherein the height is increased up to a thickness of the bezel.

7. The device of claim 6, wherein the thickness is about 0.7 millimeters.

8. The device of claim 1, further comprising a shielding to protect the display panel and antenna.

9. The device of claim 8, wherein the shielding is metal to provide electromagnetic shielding.

10. A bezel comprising:
an elongated material dimensioned to fit in a border region around a display panel, wherein the bezel is to be disposed over an antenna within a keep-out area to support a cover; and
a partially filled portion to reduce a resonance shift of the antenna.

11. The bezel of claim 10, wherein the partially filled portion is a cutout section.

12. The bezel of claim 11, wherein the cutout section is for receiving a portion of the antenna.

13. A method comprising:
mounting an antenna in a border region around a display panel, wherein the antenna has a keep-out area;
forming partially filled portions within a bezel;
disposing the bezel within the keep-out area over the antenna; and
covering the antenna with a cover, wherein the cover is supported by the bezel.

14. The method of claim 13, wherein forming the partially filled portions comprises removing material from the bezel with a uniform thickness.

15. The method of claim 13, wherein forming the partially filled portions comprises molding a bezel with the partially filled portions.
